(19) United States
(12) Patent Application Publication
(10) Pub. No.: US 2014/0250360 A1
(43) Pub. Date: Sep. 4, 2014

(54) Visual merge utility

(71) Applicants: Yizhen Jiang, Shanghai (CN); Weihua Wang, Shanghai (CN); Mark Wineman, San Diego, CA (US)

(72) Inventors: Yizhen Jiang, Shanghai (CN); Weihua Wang, Shanghai (CN); Mark Wineman, San Diego, CA (US)

(73) Assignee: Macromedia, Inc., San Francisco, CA (US)

(21) Appl. No.: 10/856,334

(22) Filed: May 28, 2004

(51) Int. Cl. G06F 17/22

(52) U.S. Cl. CPC G06F 17/2288
USPC 715/229

(57) ABSTRACT

A system and method include receiving multiple modified versions of a parent document, wherein the parent document and each of the modified versions contain code to display or define underlying information therein. The system and method also include comparing each of the multiple modified versions to the parent document to determine changes made to resulting information of the parent document by modified versions, and displaying to a user the changes made to the resulting information in an end-user type display.

### TECHNICAL FIELD

The embodiments disclosed herein relate to the field of software application development and more specifically to comparing edited documents in the development process.

### BACKGROUND OF THE INVENTION

Authors who work to create large software projects may often work with tag-based or markup language code. Documents which include tags or markup language code, such as Standard Generalized Markup Language (SGML), HyperText markup Language (HTML), or Extensible Markup Language (XML) contain underlying data that is described through use of tags, attributes, and the like. Such documents may often be associated with an object model. An object model may be considered to be a model of the information represented in a document, wherein the information is broken up into objects which are then arranged in a hierarchical structure. Further, those objects may be described by properties, with functionality added in the of methods, which work on the objects and properties.

While each author may create his own unique object model for a document or for a larger application that employs many documents, a standard object model, called the Document Object Model (DOM), exists for XML and HTML. The DOM is a World Wide Web Consortium (W3C) standard, and it is a specification for a programming interface which allows the contents of an XML or HTML document to be accessed by programming languages, such as JavaScript, C++, and the like. For example, a author may create or edit an XML document using JavaScript and may access the information in an XML document through JavaScript. In fact, much of the editing and creating of XML documents may be performed with code, such as JavaScript or C++, through the use of the DOM, such that an author creating an XML or HTML document may never actually write out raw HTML or XML code. A DOM implementation of a document is a representation of that document in memory, wherein the information represented in the document is arranged into a hierarchical node tree, as specified by the above-mentioned W3C standard.

Large software projects typically require many authors in order to bring the project to fruition as an end-user application. With many authors all working on the same project, the issue of version control often arises. Version control is a concept that includes managing edited documents to create a final, edited master version, and it often involves merging one or more edited versions of the same document to create the finally edited master version. An example scenario is when two authors independently check out the same document for editing and then later need to merge those two independently edited versions into a single parent document or master document. A traditional way of performing such version control is for one or more authors to read the edited code to find changes, and then to cut and paste desired changes into a finally edited version.

Such traditional methods may also be assisted by an editing application which compares the code in each version line-by-line and marks changes in each version such that an author may more easily spot the changes made to each version. However, such editing applications cannot usually tell the difference between superficial changes and actual changes to the resulting data. An example is an editing application that compares HTML code line-by-line and marks the changes therein. Such an editing application may not be able to determine that added white space is irrelevant and, therefore, should not be marked as a change. This limitation of traditional applications means that authors who do editing often have to be very skilled in reading code and inferring from the code how an end-user application would be affected by the code and changes thereto.

### BRIEF SUMMARY OF THE INVENTION

Accordingly, there is a need in the art for an editing application that makes changes in resulting data easier to identify and implement. There is a further need in the art for an editing application that frees authors from much of the burden of reading raw code.

Such technical advantages may be provided by the systems and methods described herein. Representative embodiments of the present invention are directed to a method for providing WYSIWYG (“what you see is what you get”) version control that includes receiving multiple modified versions of a parent document. The parent document may be, for example, an HTML document that contains code to display underlying information, when rendered. The parent document may also be, for example, an XML document that contains code to define a purpose or meaning of underlying information. While HTML and XML are two examples of document types that may benefit from various embodiments of the invention, the invention is not limited to those document types. Any document type that includes code or tags to define or describe information as it is presented to an end-user may benefit from one or more of the various embodiments described herein. The method further includes comparing the modified versions to the parent document to determine changes made to the resulting information of the parent document by each of the first and second modified versions. Comparing the modified versions to the parent document may include comparing the object model implementations of the modified versions to an object model implementation of the parent document. The method further includes displaying to a user the changes made to the resulting information in an end-user type display. The displaying may be accomplished by creating a first marked representation which includes the resulting information from one of the modified versions and the data representing the changes made to the resulting information of the parent document by that version. Similarly, a second marked representation is created which includes the resulting information from another modified version and the data representing the changes made to the resulting information of the parent document by that other modified version. Accordingly, the user may see the changes made by each version as those changes would be seen by an end-user, instead of seeing the actual changes made to the raw source code.

The method may also include merging one or more of the plurality of changes into an updated document as instructed by the user. Such merging may be implemented by allowing the user to choose the desired changes for merging into the updated document. Thus, when merging one or more versions of a parent document, the user may select changes from an end-user type display, such as a web browser, a media player, or the like. Selected changes may then be saved in the source code of the updated document. The resulting merge process allows a user to perform version control without having to read or even view the underlying raw code.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is an illustration of a system, adapted according to one embodiment of the present invention, for providing a display of document versions;

FIG. 2A is an illustration of a system, adapted according to another embodiment of the present invention, for providing a display of HTML document versions;

FIG. 2B is an illustration of HTML code;

FIG. 2C is an illustration of an end-user display of the resulting information from rendering the code of FIG. 2B;

FIG. 2D is an illustration of HTML code;

FIG. 2E is an illustration of an end-user display of the resulting information from rendering the code of FIG. 2D;

FIG. 2F is an illustration of a system, adapted according to embodiments of the present invention;

FIG. 3A is an illustration of a system, adapted according to an additional embodiment of the present invention, for providing a merge of XML document versions;

FIG. 3B is an illustration of a system, adapted according to the embodiments shown in FIGS. 3A and 3B;

FIG. 3C is an illustration of an updated XML document version transformed as a dialog box in a merge utility, adapted according to an embodiment of the present invention; and

FIG. 4 is a block diagram illustrating an exemplary method for performing version control with a WYSIWYG merge utility.

### DETAILED DESCRIPTION OF THE INVENTION

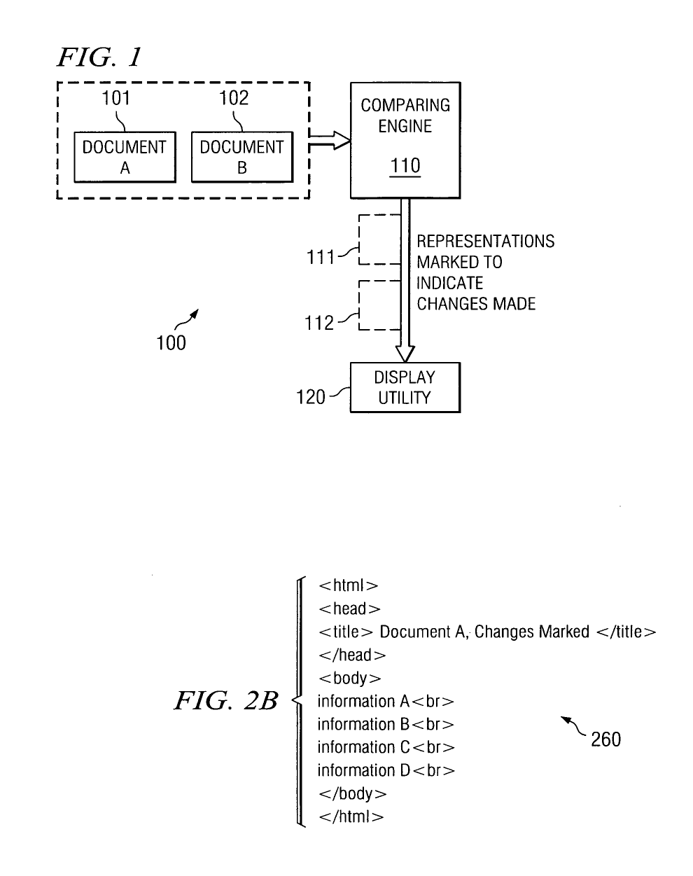

FIG. 1 is an illustration of system 100, adapted according to one embodiment of the present invention, for providing a display of document versions. System 100 includes document A 101 and document B 102, each of which are separately modified versions of a parent document (not shown) or part thereof. Document A 101 and document B 102, in some embodiments, may be XML documents, HTML documents, INI files, or other similar types of tagged or coded documents. System 100 is not limited by document type, but rather is compatible with a wide array of document types, now known or later developed, that contain information that is described by code or tags therein to produce a specified display (as in HTML) or to define the information (as in XML). In some files (such as INI files), code in the form of key/value pairs may be used to define the information therein by providing a heuristically structured quality to the file. The specified display or definition presented to a user, including the data displayed and/or defined, is the resulting information. For example, an HTML document may contain tags describing where to display an image on a web browser interface. When the HTML is rendered by the web browser, the browser produces a display as instructed by the HTML code. What the user sees, in this example, is the resulting information, which not only includes the image itself, but also includes the way that the image is presented. The user, however, sees the visual result of that information without knowing or even needing to know how those visual elements are implemented on HTML code.

Documents 101 and 102 are input into comparing engine 110, which determines the changes made to the resulting information in the parent document by each of the modified versions represented by documents 101 and 102. Comparing engine 110 may use any number of known algorithms to determine the changes to the resulting information, such as by parsing meta-data that may be included in documents 101 and 102 which may reveal changes made in each version. Another known algorithm may be to compare object model implementations of documents 101 and 102 with an object model implementation of the parent document and, from that comparison, determine changes to the resulting information. Any algorithm that compares documents to determine changes to the resulting information may be used with the various embodiments of the present invention.

An example illustration of the usefulness of the comparing engine is in the context of HTML documents. If changes are made to the source code of the parent document that include additions of large amounts of white space, and a utility makes a line-by-line comparison of the source code, the utility may indicate that a great number of changes have occurred in the edited document. The white space added in the HTML document is basically irrelevant information, and is typically ignored when rendering the HTML document. Comparing engine 110 searches for changes to the resulting information instead of sample changes to the source code. In this case the resulting information corresponds to the display presented to a user after rendering the HTML code. Thus, because the added white space is irrelevant, comparing engine 110 ignores the added white space and indicates changes where the resulting information has truly been changed.

When the comparison is completed, comparing engine 110 outputs representations 111 and 112, which are processed versions of documents 101 and 102, respectively, with the changes to the data marked. In some embodiments, representations 111 and 112 may be actual documents, and in other embodiments, representations 111 and 112 may be representations in random access memory (RAM). Representations 111 and 112 may conform to any of a variety of document types, including, but not limited to, text, XML, or HTML. Display utility 120 reads representations 111 and 112 and displays them to a user in a WYSIWYG fashion with the changes marked, for example, in red lines, highlighted in a specific color, or the like. The display may include a split screen with each of the two representations occupying one half of the screen; however, various forms of display may be implemented in different embodiments of the present invention. By displaying representations in a WYSIWYG fashion, display utility 120 presents representations 111 and 112 as the representations would appear to an end-user who is interacting with a utility operable to display the parent document. For example, if the parent document and documents 101 and 102 are HTML documents, display utility 120, which may provide web browser functionality, displays to the user the resulting information and changes to the resulting information in rendered HTML, such that the user may actually see how the differences affect a final version, rather than having to look at HTML code to discern the changes. Another example is that if documents 101 and 102 are independently edited versions of code for a newly designed dialog box, display utility 120 displays the two versions of the dialog box, with changes marked, instead of displaying the source code in each of the documents.

System 100 may include merge functionality, such that a user may interface with display utility 120 to manually select those changes from documents 101 and 102 that he or she desires to include in the updated version. The updated version is a version created through merging one or more edited versions, and it may include all, some, or none of the changes from each of the edited versions. Display utility 120 with merge functionality may, for example, display versions with changes marked in a top split screen while on bottom displaying an updated version. A user may then use a mouse or other pointing device to select edits to add to the updated version while display utility 120 shows the user the appearance of the updated version with such changes. Display utility 120 then saves the edits to the updated version in the same format as that of the parent document. For example, if the parent document is an XML file, display utility 120 saves the changes to an updated XML file so that the user may access a ready-to-use updated version.

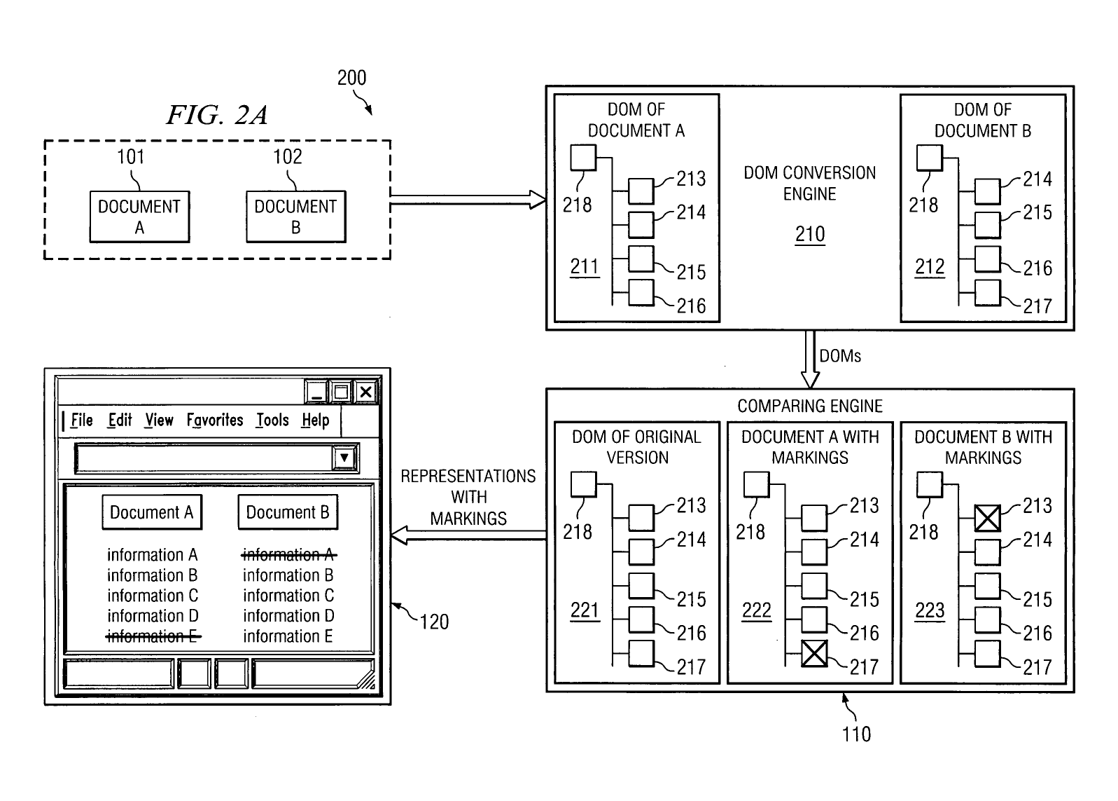

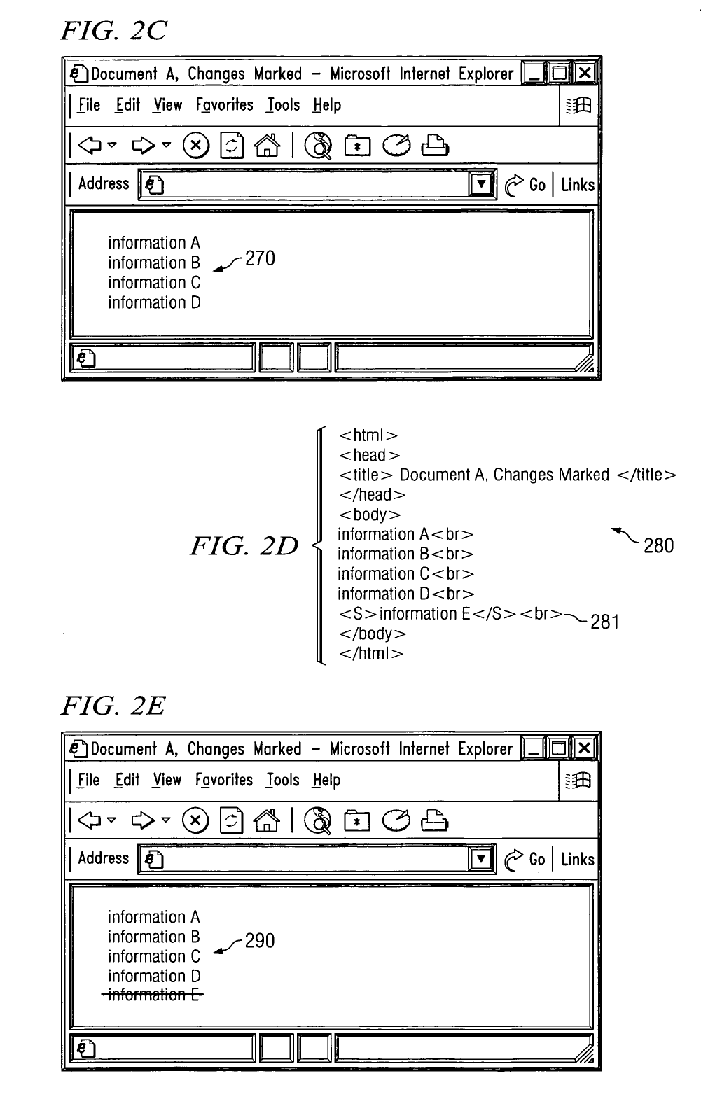

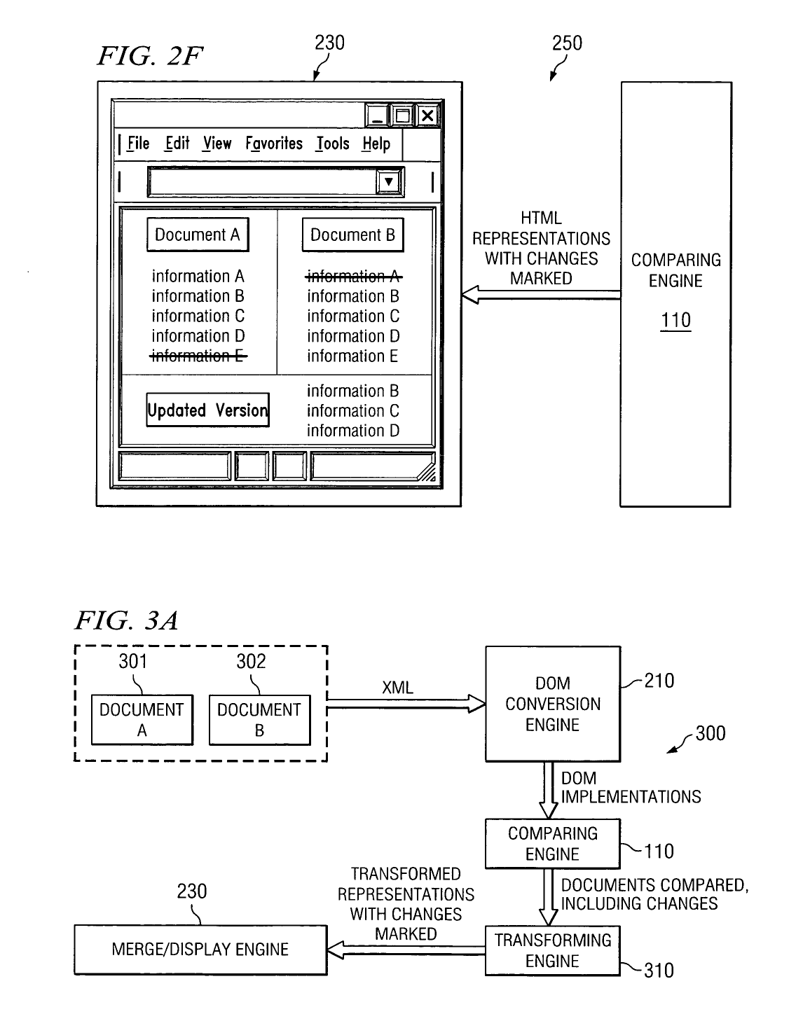

FIG. 2A is an illustration of system 200, adapted according to another embodiment of the present invention, for providing a display of HTML document versions. System 200 includes document A 101 and document B 102, each of which are separately modified versions of a parent document (not shown) or part thereof. Document A 101 and document B 102, in this embodiment, are HTML documents.

DOM conversion engine 210 creates DOM implementations 211 and 212 from documents 101 and 102. DOM conversion engine 210 may be a commercially available application, such as MSXML PARSER (available from MICROSOFT), TIDYLIB (available from SOURCEFORGE), or the MICROSOFT HTML module that comes with MICROSOFT INTERNET EXPLORER. It may also be a custom conversion engine, including one that may utilize a combination of functionalities of the commercially available applications. Other DOM conversions products exist for HTML and XML documents and are within the scope of embodiments of the present invention. System 100 is not limited by DOM conversion products, but rather may utilize any appropriate DOM implementation creation product or application now known or later developed.

It should be noted that comparing DOM implementations of documents is only one example of how to compare documents. Accordingly, embodiments of the present invention that do not compare DOM implementations would not include a DOM conversion engine, such as DOM conversion engine 210. Further, some XML or HTML documents may already be associated with a DOM implementation in which case DOM conversion engine 210 may be bypassed.

The significance of a DOM implementation, such as implementations 211 and 212, is that such an implementation organizes the resulting information in a standard object model that provides a hierarchical arrangement of the resulting information and allows applications to directly access the data in the underlying source document. For example, two authors may independently write an HTML document that displays the same content in the same layout. The HTML documents, when rendered, may be identical. However, because the two authors worked independently, the underlying source code in each document may differ from the other document. For example, the amount of white space included in the code or comments inserted into the code may be different. Moreover, if a particular portion of the web page is very complex in its display, the underlying source code may be quite divergent. Even though the underlying code may differ, if the resulting information is the same, then the DOM implementations should be organized in the same manner, such that common pieces of data are arranged in the DOM implementation in the same way in both documents. Because of the organizational nature of the DOM implementation, added or deleted information may also be easy to identify as corresponding to added or deleted nodes in the DOM implementation node trees.

While this example illustrates how a DOM may help to identify changes in an HTML document, a DOM may also help to identify changes in an XML document. For example, in XML, the order of child nodes on a parent node may often be irrelevant, such that a DOM implementation of a version of an XML document wherein the order of the child nodes has been changed may often be identical to the DOM implementation of the original version. Thus, DOM implementations are one way to help identify changes in the resulting information rather than the differences in the source code itself.

In the embodiment illustrated in FIG. 2A, each DOM implementation 211 and 212 is a hierarchical arrangement of objects, such that, for example, object 218 is a parent object, and objects 213-216 are child objects. In this example embodiment, DOM implementations 211 and 212 reveal that each one has three child objects in common with the other, 214-216. Each implementation 211 and 212 also has an object not in common with the child objects of the other, 213 and 217, respectively. Thus, the resulting information in documents 101 and 102 is similar in each of those documents, while still containing some different content. It should be noted that DOM implementations 211 and 212 show only four child objects and one parent object each. However, this representation for purposes of the example of FIG. 2A should not be considered limiting in the various embodiments of the present invention. In operation, DOM implementations may include many more levels in the hierarchy and many more objects. System 100 is not limited in the size of documents 101 and 102 that it may process, as long as it is equipped with hardware and software resources that facilitate documents of a particular size.

Comparing engine 110 compares parent version DOM 221 with modified version DOMs 211 and 212. In this example embodiment, DOM implementation 221 includes five child objects, 213-217. Thus, parent implementation 221 includes child objects 214-216 that implementations 211 and 212 have in common and also contains child objects 213 and 217 that each of respective implementations 211 and 212 uniquely included. Comparing engine 110 contains logic, which, when executed, compares each of implementations 211 and 212 to parent document implementation 221 and produces comparison representations 222 and 223.

In this example, comparing engine 110 compares implementations 211 and 212 to implementation 221 and determines that each of documents 101 and 102 omits information which was included in the parent document. Such omitted information is represented by object 217 (which was omitted by document A 101) and object 213 (which was omitted from document B 102). Comparing engine 110 then produces representations 222 and 223, which are versions of documents 101 and 102 with markings to show changes made. In this example, markings to show changes made in representation 222 are accomplished by appending child object 217 and including information about object 217 in the form of attributes or child nodes to make object 217 stand out. Such information about object 217 may, for example, include a tag or attribute that instructs a viewing application to present the information in object 217 with a strike-through effect, a color effect, bolding, or some other visual identification means and may also include data to tell a receiving application that the deletion of object 217 from document A 101 is a change that may be merged into an updated document.

Markings to show changes made in representation 223 may be accomplished in a similar manner. Many ways exist to create representations 222 and 223 with markings to show changes, and all are within the scope of embodiments of the invention. Representations 222 and 223, in this example, are HTML documents; however, any kind of document that may be coded and displayed to a user in a special, visual manner that is associated with the coding may be employed.

HTML representations 222 and 223 are then received by displaying engine 120. Displaying engine 120, in this embodiment, contains logic, which, when executed, displays representations 222 and 223 including the appropriate markings, as the data would appear to a user, to indicate changes made from the parent document. Displaying engine 120 may be a web browser configured with extra capabilities to display multiple documents on the same screen at the same time in a split-screen arrangement so that a user may view the changes made in each of document A 101 and document B 102 simultaneously. In this example, displaying engine 120 displays a version of document A 101 showing that document A 101 omits information E, which corresponds to object 217. Displaying engine 120 also displays a version of document B 102 showing that document B 102 omits information A, which corresponds to object 213.

Thus, system 200, in the example described in FIG. 2A, displays to a viewer changes made to a document by two independent users or one user in two separate versions. System 200 is a WYSIWYG version control display in that, instead of displaying to the viewer the changes made in the underlying source code of documents 101 and 102, system 200 displays to a viewer the changes made as they would appear to an end-user, such as rendered HTML in this embodiment, thereby allowing a viewer to see how such changes affect the resulting information of a document rather than having to infer from the source code how such changes would affect the document.

A simple example of the difference between presenting to a user source code and presenting changes made in an end-user type display is illustrated by FIGS. 2B, 2C, 2D, and 2E. FIG. 2B is an illustration of HTML code 260. FIG. 2C is an illustration of end-user display 270 of the resulting information from rendering code 260 of FIG. 2B. FIG. 2D is an illustration of HTML code 280. FIG. 2E is an illustration of end-user display 290 of the resulting information from rendering code 280 of FIG. 2D. End-user display 290, in this example, is produced by a web browser that reads HTML code 280 and renders a display for an end-user. During rendering, a web browser displays the content of the HTML code, and uses the tags and attributes (if applicable) to determine the display qualities of the content. In this example, HTML code 280 (FIG. 2D) includes code 281 which contains tags “<s>” and “<s>” that instruct the browser to display content, information E, in a strikethrough font. For illustrative purposes only, information A-D of FIG. 2A, as presented in document A 101, is textual information (content) that reads, “information A,” “information B,” “information C,” and “information D,” as illustrated in HTML code in FIG. 2B and in resulting information in FIG. 2C.

For purpose of this example, comparing engine 110 indicates an omission in the changes marked representation 222 as strike-through font. Code 280 in FIG. 2D is exemplary code, which, when rendered, displays to a user resulting information, as in display 290 of FIG. 2E. Code 280, in this example, is code that may be included in representation 222, the changes-marked representation corresponding to document A 101, which, when rendered, indicates that “information E” is omitted by the version embodied in document A 101. Display 290 of FIG. 2E is an end-user type display, as may be produced by displaying engine 120 of FIG. 2A through rendering code 280 of representation 222.

In this example, the change in resulting information is the fact that “information E” is not a part of display 270 of FIG. 2C. In this case, a user may know that “information E” has been omitted in document A 101 by viewing display 290 (through use of displaying engine 120) and noticing that “information E” is stricken out. Thus, the user does not have to read raw HTML code to determine changes to resulting information. In traditional systems, a user might have to read code 260 to infer that “information E” has been omitted. In this example, the user is not burdened by having to read raw code because changes in resulting information are displayed to the user as rendered HTML code, which is the way that most users are used to viewing resulting information. While in this example, deletion of information E is a relatively simple deletion that may be quickly noticed in a marked-up version of the underlying code, real-life, practical applications often contain complex coding which would make it very difficult for many users to notice what has changed in a marked-up version of the underlying code.

Displaying changes in an end-user type fashion may be referred to as a WYSIWYG display because the user sees the changes as the changes would appear in an executing end-user program. Thus, the user sees what the user will get in the end product. WYSIWYG version control display may be especially useful when applied to changes made to large HTML documents. As mentioned earlier, in an HTML document, a viewer may find it difficult to understand how a change to the source code affects the resulting information of the HTML document. The problem may be compounded in larger, more complex documents by the fact that equivalent changes to the resulting information may be accomplished by a number of different, though equally correct, changes to the source code. The WYSIWYG display, however, presents to the user a rendered, visual depiction of the changes made to the resulting information itself such that the user may not have to be concerned with the mechanics of HTML code.

FIG. 2F is an illustration of system 250, adapted according to an additional embodiment of the present invention. In this example embodiment, merge/display engine 230 receives HTML representations with changes marked from comparing engine 110 similar to the manner in which display engine 120 receives HTML documents. Merge/display engine 230 displays changes made to documents 101 and 102. Merge/display engine 230 also displays an updated version to a user, which includes user-selected modifications from modified versions 101 and 102. Merge/display engine 230 contains logic, which, when executed, allows a user to examine changes made to the resulting information of a parent document in one or more modified versions and to choose to implement some, all, or none of the changes in the updated version. In this example, merge/display engine 230 displays changes made in document A 101 on the top left and changes made in document B on the top right in a manner similar to the display by display engine 120 (FIG. 1). Merge/display engine 230 also allows a view of an updated version. A viewer may then choose the changes that he or she would like to adopt from the modified versions and see the changes implemented in the updated version.

In this example, a user (not shown) has selected to implement the change in document A 101 and the change in document B 102 such that the updated document omits both information A and information E, while including information B-D, which corresponds to objects 214-216 in DOM implementations 211 and 212. Merge/display engine 230 saves those changes to the updated version of the document. In this embodiment, the updated version is an HTML document, such that merge/display engine 230 saves the changes in an HTML document. Some embodiments may allow a user to pick and choose discrete changes from each modified document version, while other embodiments may only allow a user to pick all or none of the changes from one or more document versions. Still other embodiments may implement a combination or allow a user to pick between discrete changes and entire modification versions. It is within the scope of embodiments to allow a user as much or as little latitude as is appropriate to select changes to implement in an updated document.

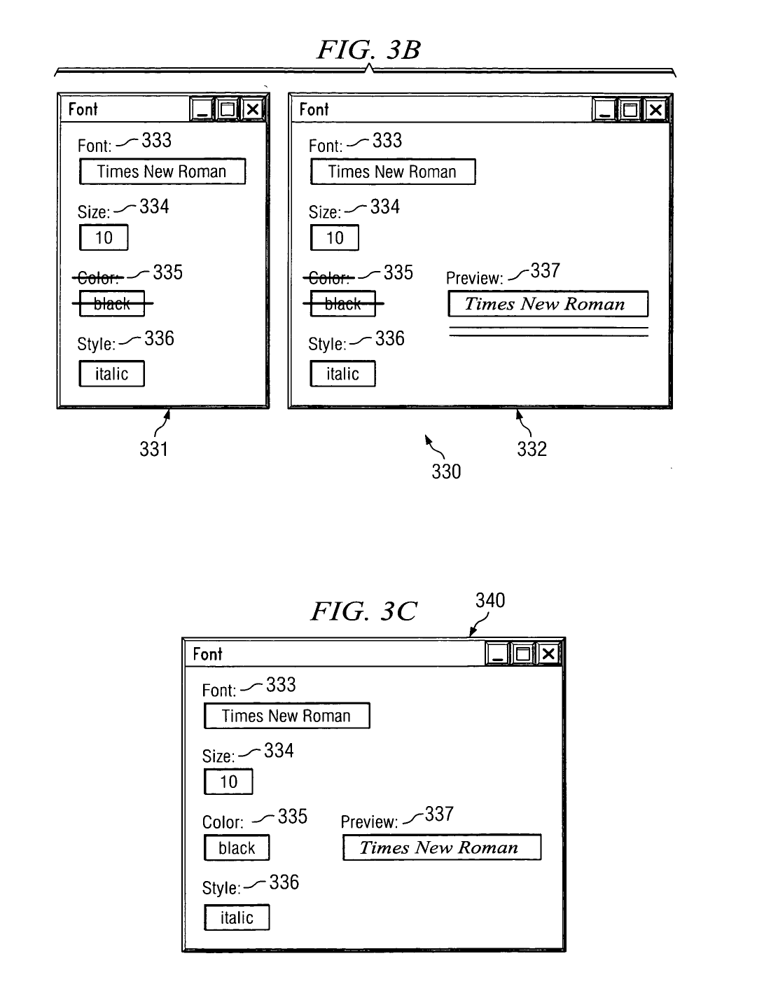

As discussed earlier, various embodiments of the present invention may start with documents from a wide variety of formats, including XML documents and HTML documents, among others. FIG. 3A is an illustration of system 300, adapted according to an additional embodiment of the present invention for providing a merge of XML document versions.

In this example embodiment, document A 301 and document B 302 are each modified versions of a parent XML document, and are, themselves, made up of raw XML code. XML code contains tags, similar to the tags in HTML, to describe underlying data in the code. In XML, the tags define a purpose or meaning of the data. For example, an XML file that describes characteristics of a piece of merchandise may show that the price of the merchandise is $3.00. Accordingly, an XML element, such as <price>three dollars</price>, may be included in the XML file. In this example, “three dollars” is the underlying data, and it is defined as a “price.” Both XML and HTML use tags to describe qualities of underlying data. In XML, the tags are used to define a purpose or meaning of the data, and in HTML, the tags are used to define how the data is displayed.

DOM conversion engine 210 creates DOM implementations of documents 301 and 302. The DOM implementations of documents 301 and 302 are then compared by comparing engine 110 against a DOM implementation of the parent XML document. Comparing engine 110 determines the changes made to the resulting information and includes code or restrictions that mark the changes to each document 301 and 302 and creates representations with those changes marked. The representations with changes marked are then transformed by transforming engine 310 with the changes marked into HTML documents. Such functionality may include applying Extensible Stylesheet Language Transformation (XSLT) to the documents to transform the XML into HTML. XSLT are processing extensions to the XSL Language that operate to transform XML documents into a variety of other documents, such as text, PDF, and XML documents with different schemas. In this example, the transformation from XML to HTML is operable to define a display of the marked changes in the documents.

In this example, the HTML documents produced by the XSLT contain code that, when rendered, displays versions of documents 301 and 302 with the changes to the resulting information visually marked. Merge/display engine 230 displays the changes to the resulting information to the user through a WYSIWYG merge functionality that allows the viewer to implement or select the changes to the resulting information visually.

System 300 may also be employed in an embodiment for editing a dialog box. In this example, documents 301 and 302 are XML documents which provide content to produce a dialog box. Producing a dialog box may include, for example, using a program to execute code or a script (such as C++, Visual Basic, or JavaScript) to create a dialog box, including its various qualities, such as location, appearance, features, etc. Documents 301 and 302 provide content, which when accessed by the code-executing program, is used to provide many of the display qualities of the dialog box. Thus, the resulting information is a dialog box with the qualities specified in the XML document. DOM implementations of documents 301 and 302 are created by DOM conversion engine 210. Comparing engine 110 compares the DOM implementations and outputs a representation with changes marked for each one. Transforming engine 310 then transforms the XML to produce a dialog box for each representation. Merge/display engine 230 then displays the marked-up versions to a user-developer in a WYSIWYG or end-user fashion. In some alternate embodiments, the XML transforming functionality of transforming engine 310 may be included in merge/display engine 230, thereby obviating the need for a separate transforming engine. In this embodiment, the end-user is a person who interacts with the dialog box in its resident application, for example, in a word-processing program. Thus merge/display engine 230 presents to the user two dialog boxes as they would appear in the resident application defined by each XML version. The dialog boxes could be displayed on merge/display engine 230 with all of the changes marked.

FIG. 3B is an illustration of system 330, adapted according to the embodiments shown in FIG. 3A. In this example, dialog boxes 331 and 332 are presented as they might appear to an end-user or a user/developer via merge/display engine 230's display functionality. Further, dialog boxes 331 and 332 are produced by two different versions of parent XML document (such as documents 301 and 302 in FIG. 3A), and they each have markings to show the changes made from the parent document, such that, in this particular example, deletions are marked by strikethroughs and additions are marked by double underlines. In this example, dialog box 331 hosts features 333-336, and dialog box 332 hosts features 333-337. As can be seen, both dialog boxes 331 and 332 omit color feature 335 from the parent dialog box, while dialog box 332 adds preview feature 337, which was not present in the parent version.

FIG. 3C is an illustration of an updated XML document version transformed as dialog box 340 in a merge utility, adapted according to an embodiment of the present invention. Dialog box 340 is a dialog box produced in a merge utility from an updated version of the XML document. In this particular example, a viewer has employed the merge functionality of merge/display engine 230 to select the desired changes from each of the multiple versions (represented by documents 301 and 302 and dialog boxes 331 and 332 of FIG. 3B) for incorporation into the updated version. As shown, the user or viewer has selected to ignore the deletion of color feature 335 (of FIG. 3B) by each version and to incorporate the addition of preview feature 337(of FIG. 3B). In this embodiment of the merge utility, a viewer may select among changes in an intuitive manner, such as by using a mouse to navigate a cursor and select the desired changes by left clicking (or double clicking, right clicking, or the like) on various changes in each of the versions. Further, merge/display engine 230 is operable to save the updated version as an XML document, the same format as the parent document.

Thus, these example embodiments illustrated in FIGS. 3A, 3B, and 3C allow a user or viewer to implement changes to the underlying code in an XML document by selecting rendered changes representing resulting data from multiple modified versions of that underlying document code. Such an embodiment may facilitate visual version control by providing more intuitive merge and display functionality. This visual inspection systems makes designing and editing easier for users who may not be familiar with raw XML code.

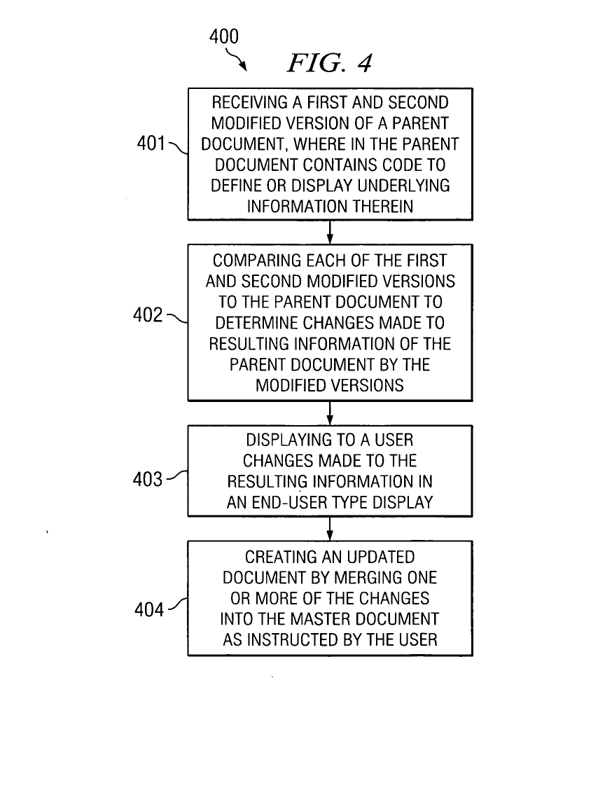

FIG. 4 is a flow chart illustrating exemplary steps in implementing method 400 for performing version control with a WYSIWYG merge utility designed according to an embodiment of the present invention. In block 401, a merge application receives two modified versions of a parent document. The modified versions may be independently created by separate users, two versions created by the same user, or the like. While this exemplary embodiment describes version control performed for two different modified versions, any number of modified versions are within the scope of the various embodiments. Further, the parent document may be an HTML document, such that the modified versions are also HTML documents. Any type of document, including HTML and XML, that contains information described by code or tags to be defined or displayed in a specified way as resulting information, is also within the scope of the various embodiments.

In block 402, the application compares the modified versions to the parent document to determine changes made to the resulting information of the parent document by the modified versions. Comparing the modified versions to the parent document may include creating DOMs of the modified versions and comparing those DOMs to a DOM implementation of the parent document. Comparing the resulting information may also include parsing data and meta-data in the modified versions and in the parent document to determine the changes to the resulting information. Any algorithm for comparing the modified versions to the parent document is within the scope of the various embodiments.

In block 403, the application displays to a user changes made to the resulting information in an end-user type display. This may be accomplished through creating a marked representation for each of the modified versions. Each marked representation includes the resulting information and data representing changes made to the resulting information of the parent document by the respective modified version. These marked representations, therefore, may be marked-up versions of each of the modified versions showing the changes made. The markups may, for example, be redline versions of the modified versions with omissions in a strike-through font and additions underlined. The markups may also use different colors of text to symbolize changes. Additionally, the markups may also use a variety of methods to visually show that objects, such as pictures, have been moved, added, or deleted. Any manner for representing changes made to a document, now known or later developed are within the scope of embodiments. Further, the representations with changes marked may be actual documents or may simply be representations in memory.

The changes made are displayed in an end-user type fashion. Such a display presents to the user the documents as they would appear when executed. For example, if the parent document is an HTML document, the marked documents may be displayed in rendered HTML, such as by a web browser. In this manner, the user sees the marked documents as they would appear in an end-user application, rather than as source code. In another example, the parent document may be a document, which when executed, produces a dialog box. The application would then display to the user the two marked versions as dialog boxes with the changes from the parent displayed thereon. Thus, in these examples, the application displays to the user the marked documents in a way such that the user may see the changes as they would appear to an end-user, and in some instances that means as rendered HTML rather than as source code or marked-up source code.

In block 404, the application creates an updated document by merging one or more of the changes into the updated document as instructed by the user. In an example embodiment, the user may pick desired edits by moving a cursor over the marked changes and clicking a mouse. In some embodiments, the user may choose any of the marked changes to merge into the updated document. In other embodiments, a user may choose all of the edits from one or both versions to merge into the updated document. Any manner of allowing a user to pick changes and to instruct the application to merge such changes are within the scope of the various embodiments. Further, the application may save the updated document in the same format as that of the parent document. For example, if the modified versions are changes made to an XML document, the updated document may also be an XML document so that authors working to complete a project involving the parent document may quickly utilize the updated document as they would utilize the parent document.

Thus, a user may create a new parent document from independently-edited versions of the old parent document. These example embodiments provide a user with a end-user display of changes made to the parent document. Merge functionality of these example embodiments of the application allows a user to pick changes from an end-user type visual display and merge those changes into an updated document, which the user may also view in an end-user type display. Such embodiments may also allow a user to merge changes in a wide variety of document formats, including XML, HTML, SGML, INI, and the like. Though many of the example embodiments teach creating DOM implementations and comparing those DOM implementations, any kind of object model, including, but not limited to, proprietary object models and Document Object Models are within the scope of embodiments. Some embodiments may not employ DOMs at all, but may instead use another algorithm to compare data. Further, though many of the examples teach displaying and merging changes from two modified versions, systems and methods which employ any number of modified versions are within the scope of the invention.

Although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A processor implemented method comprising:
receiving a parent document that comprises source code that when interpreted by an interpreter renders an output presentation;
comparing an object model of a first modified version of the parent document to an object model of the parent document to identify changes made by the first modified version to the output presentation rendered by the interpreter, wherein the parent document and first modified version comprise underlying information and code with tags that describe at least one quality for displaying the underlying information in the output presentation, wherein the changes identified correspond to differences between the output presentation as interpreted from the parent document and the output presentation as interpreted from the first modified version of the parent document; and
displaying the output presentation in an end-user fashion, wherein the output presentation is displayed with markings showing the differences between the output presentation as interpreted from the parent document and the output presentation as interpreted from the first modified version of the parent document.

2. The method of claim 1 wherein displaying comprises visually presenting the underlying information and the at least one quality.

3. The method of claim 1 further comprising:
comparing an object model of a second modified version of a parent document to the object model of the parent document to identify changes made by the second modified version to the output presentation rendered by the interpreter, wherein the second modified version comprises underlying information and code with tags that describe at least one quality for displaying the underlying information in the output presentation, wherein the changes made by the second modified version correspond to differences between the output presentation as interpreted from the parent document and the output presentation as interpreted from the second modified version of the parent document;
displaying the output presentation by the second modified version in an end-user fashion, wherein the output presentation by the second modified version is displayed with markings showing the differences between the output presentation as interpreted from the parent document and the output presentation as interpreted from the second modified version of the parent document.

4. The method of claim 1 further comprising merging one or more of the changes into an updated document based on user instruction.

5. The method of claim 4 wherein merging comprises:
presenting options to select one or more of the changes for merging into the updated document; and
incorporating into source code of the updated document the one or more of the changes selected.

6. The method of claim 4 wherein changes made to the output presentation by the first and second modified versions are displayed with the updated document on one screen.

7. (canceled)

8. A processor implemented method comprising:
receiving a first and a second modified version of a parent document, wherein the parent document comprises underlying information and code with tags that define at least one quality for displaying the underlying information when said code of said parent document is interpreted by an interpreter to render an output presentation;
comparing each of the first and second modified versions to the parent document to determine changes made to a rendered output presentation of the parent document by the first and second modified versions; and
displaying the rendered output presentation with the at least one quality by said interpreter rendering said code to create an end-user type display, wherein the rendered output presentation is displayed:
with markings showing first differences between the output presentation as interpreted from the parent document and the output presentation as interpreted from the first modified version of the parent document; and
with markings showing second differences between the output presentation as interpreted from the parent document and the output presentation as interpreted from the second modified version of the parent document.

9. (canceled)

10. The method of claim 8 further comprising merging one or more of the changes into an updated document as instructed.

11. The method of claim 10 wherein merging comprises:
presenting options to select one or more of the changes for merging into the updated document; and
incorporating into source code of the updated document the one or more of the changes selected.

12. The method of claim 10 further comprising saving the updated document in a format according to a format of the parent document.

13. The method of claim 8 wherein displaying comprises visually presenting the information and the at least one quality in the marked documents by rendered code.

14. The method of claim 8 wherein comparing comprises determining that a change made to an order of child nodes on a parent node is not a change made to the rendered output presentation of the parent document.

15. The method of claim 8 further comprising:
receiving a third modified version of the parent document;
comparing the third modified version to the parent document to determine changes made to the rendered output presentation of the parent document by the third modified version; and
wherein the rendered output presentation is displayed with markings showing third differences between the output presentation as interpreted from the parent document and the output presentation as interpreted from the third modified version of the parent document.

16. The method of claim 8 wherein displaying comprises executing the code in a display for showing the first differences and the second differences and the at least one quality.

17. The method of claim 8 wherein the at least one quality of the underlying information is a meaning, a purpose, or a visual appearance.

18. The method of claim 8 wherein the comparing rendered output presentation in each modified version to rendered output presentation in the parent document comprises comparing an object model implementation of each of the first and second modified versions to an object model implementation of the parent document.

19. The method of claim 18 wherein the object model implementations are DOM implementations.

20.-35. (canceled)

36. The method of claim 1 wherein said object models comprise models of the underlying information represented in their respective version, wherein the underlying information is broken up into objects which are then arranged in a hierarchical structure.

37. (canceled)

38. A processor implemented method comprising:
receiving a parent source code document that comprises source code that when interpreted by an interpreter renders a first output presentation, wherein the parent source code document comprises underlying information and code with tags that describe at least one quality for displaying the underlying information in the first output presentation;
receiving at least a first modified version of the parent source code document, said at least a first modified version of the parent source code document comprising source code that when interpreted by the interpreter renders a second output presentation; and
presenting a user interface that comprises markings showing differences between the first output presentation and the second output presentation.

39. The method of claim 38 wherein the presenting comprises:
presenting said second output presentation with at least one marking showing and differentiating displayed items included in only one of the second output presentation and the first output presentation.

40. The method of claim 39 wherein said presenting further comprises:
presenting a first marking differentiating a first displayed item included in the first output presentation but not the second output presentation, the first marking providing a visual indication that the displayed item is included in the first presentation but not the second presentation.

41. The method of claim 39 wherein said presenting further comprises:
presenting a first marking differentiating a first displayed item included in the first output presentation but not the second output presentation, the first marking providing a visual indication that the displayed item is included in the first presentation but not the second presentation; and
presenting a second marking differentiating a second displayed item included in the second output presentation but not the first output presentation, the second marking providing a visual indication that the displayed item is included in the second presentation but not the first presentation.

42. The method of claim 41 wherein said first marking comprises at least one of a strike-through effect, a color-effect, a bolding effect, and a highlighting-effect applied to said content that is present in the first output presentation that is not present in the second output presentation.

43. The method of claim 38 wherein said parent source code document comprises a source code document for a web page; said at least a first modified version of the parent source code document comprises a modified source code document for the web page; and wherein said interpreter comprises a browser.

44. The method of claim 38 further comprising:
enabling a user to interaction with the user interface to select ones of the differences between the first output presentation and the second output presentation to be included in an updated version of the parent source code document.

45. The method of claim 44 further comprising:
presenting the updated version of the parent source code document in a portion of the user interface.

46. The method of claim 38 wherein said receiving the parent source code document, receiving the at least a first modified version of the parent source code document, and presenting the user interface are performed by a software application stored to a computer-readable storage medium and executing on a processor based computer.

47. The method of claim 38 further comprising:
comparing an object model of the at least a first modified version of the parent source code document to an object model of the parent source code document to identify said differences between the first output presentation and the second output presentation.

48. The method of claim 47 wherein presenting the user interface that comprises markings showing differences between the first output presentation and the second output presentation comprises including attribute information about an object to make the object stand out in the output presentation.

49. The method of claim 48 wherein the attribute information about the object comprises a tag that instructs a viewing application to present a visual identification in the output presentation.

50. The method of claim 48 wherein presenting the user interface that comprises markings showing differences between the first output presentation and the second output presentation comprises transforming a representation comprising a marked change into HTML operable to define the display of the marked change for display in the output presentation.

51. The method of claim 38 wherein the source code of the first modified version comprises user-edited source code.
